(19) United States
(12) Patent Application Publication
(10) Pub. No.: US 2011/0178903 A1
(43) Pub. Date: Jul. 21, 2011

(54) PERSONAL IDENTIFICATION NUMBER CHANGING SYSTEM AND METHOD

(75) Inventors: Amanda Jane Adams, Chester (GB); Richard John Woodward, Warrington (GB)

(73) Assignee: BANK OF AMERICA CORPORATION, Charlotte, NC (US)

(21) Appl. No.: 12/752,567

(22) Filed: Apr. 1, 2010

Related U.S. Application Data
(60) Provisional application No. 61/295,515, filed on Jan. 15, 2010.

(51) Int. Cl. G06Q 40/00; G06K 7/01; G06Q 10/00

(52) U.S. Cl. 705/30; 235/382.5; 705/35; 235/439

(57) ABSTRACT

Systems and methods are provided for enabling a cardholder to authenticate and change a current PIN associated with a chip card using a chip card interface device (CCID) having a chip card input/output device configured for interacting with the chip card. A PIN entry device receives from the cardholder a current PIN, which is communicated to the chip card along with a verify command. The chip card compares the current PIN input by the cardholder with the PIN stored on the chip card. If the cardholder input is verified, the cardholder can input a desired new PIN. The CCID then communicates a locked PIN through a host to the issuing bank's backend system, which unlocks the PIN and stores the desired PIN. The backend system then creates a PIN change script including the new PIN and communicates the script to the chip card over the network. The chip card runs the script, which instructs the chip card to store the new PIN in place of the previous PIN.

### CLAIM OF PRIORITY UNDER 35 U.S.C. §119

This Non-provisional patent application claims priority to Provisional Patent Application Ser. No. 61/295,515 titled “Personal Identification Number Changing System and Method,” filed Jan. 15, 2010, assigned to the assignee hereof and hereby expressly incorporated by reference herein.

### FIELD

In general, embodiments of the invention relate to authentication of devices used during a transaction, and, more particularly, relate to systems, methods, and computer program products for changing a personal identification number associated with a transaction device such as a credit/debit card apart from an automated teller machine network.

### BACKGROUND

Bank cards, including credit and debit cards, are used by cardholders to make purchases, cash withdrawals, and other financial transactions at bank card machines, such as automated teller machines (ATMs), point-of-sale (POS) terminals, and the like. For example, one type of bank card has a magnetic strip that holds information about a credit or debit account. The cardholder can then access the credit or debit account by, for example, swiping the bank card by a magnetic strip reader on the bank card machine. A newer type of bank card, generally referred to as a “chip card,” “smart card,” or “integrated circuit card” includes an on-card electronic chip such as a processor, microprocessor, memory, another type of electronic chip, or combinations of these devices.

Such chip cards provide the opportunity for localized storing of application(s) and data such as one or more personal identification number(s) (PINS) in a secure format. During a transaction, authentication can be performed locally at the POS terminal without requiring online authentication. Such local authentication is more effective than previous attempts for local authentication because of the possibility of additional security such as encryption of PINs stored on chip cards.

When a chip card is issued by an issuing bank, the PIN is determined beforehand and stored in the memory of the chip card. The PIN can be changed by the account-owner (referred to as a “customer”) by establishing an online connection to the backend systems maintained by an issuing bank through an ATM. In fact, in some arrangements, card issuers and/or regulators require changes of the PIN periodically in order to strengthen security. ATM network infrastructure in some areas of the world is insufficient for providing convenient access to an ATM for some customers. Further, ATM networks are typically owned and operated by one or several banks having contractual agreements with one another allowing for the use and sharing of various ATM network resources. However, in some areas, one or more banks actively doing business in such areas do not have access to pre-existing ATM networks due to the unwillingness of ATM network owners to contractually partner with those banks in an ATM network sharing arrangement. Thus, in many situations worldwide, regardless of the existence of strong ATM networks, many banks' customers do not have access to existing ATMs.

Therefore, systems, methods, and computer-program products are needed to allow a customer to change a PIN associated with a chip card without requiring use of an ATM.

### SUMMARY

Systems, methods, and computer program products are provided for enabling a cardholder to authenticate and change a current PIN associated with a chip card using a chip card interface device (CCID) having a chip card input/output device configured for interacting with the chip card. A PIN entry device receives from the cardholder a current PIN, which is communicated to the chip card along with a verify command. The chip card compares the current PIN input by the cardholder with the PIN stored on the chip card. If the cardholder input is verified, the cardholder can input a desired new PIN. The CCID then communicates a locked PIN through a host to the issuing bank's backend system, which unlocks the PIN and stores the desired PIN. The backend system then creates a PIN change script including the new PIN and communicates the script to the chip card over the network. The chip card runs the script, which instructs the chip card to store the new PIN in place of the previous PIN.

According to one embodiment of the present invention, a chip card interface device (CCID) is configured for communicating with a chip card issued by an issuing bank and having an embedded processing device connected with an embedded memory device and carried by a cardholder. The chip card interface device is configured for authenticating and changing a personal identification number (PIN) stored in the memory device of the chip card and includes a PIN entry device (PED) configured for receiving a cardholder current PIN and a cardholder desired new PIN and a chip card input/output device configured for communicating a verify command to the chip card. The verify command includes data corresponding to the received cardholder current PIN, and the chip card input/output device is also configured for receiving a verification message from the chip card indicating that authentication of the cardholder current PIN was successful. The CCID also includes a network communication device configured for communicating the cardholder desired new PIN to a host and across a network to a backend system maintained by the issuing bank. The network communication device is further configured for receiving a PIN change script from the backend system and forwarding the PIN change script to the chip card.

In some embodiments, the network communication device is further configured for initiating an online session with the backend system maintained by the issuing bank before communicating the cardholder desired PIN to the backend system. In other embodiments, the PED is further configured for receiving a first cardholder desired PIN and a second cardholder desired PIN, and the CCID also includes a processing device configured for comparing the first cardholder desired PIN and the second cardholder desired PIN after the chip card input/output device communicates the cardholder current PIN to the chip card and before the network communication device communicates the cardholder desired PIN to a backend system. In some such embodiments, the processing device is further configured for re-receiving the cardholder desired PIN if the first cardholder desired PIN does not match the second cardholder desired PIN.

In some embodiments, the network communication device is further configured for communicating the cardholder desired PIN through a host to the backend system. In some embodiments, the network communication device is further configured for communicating through a host with the backend system. In some embodiments, the PED is further configured for reading account identification information from the chip card, and the network communication device is further configured for receiving account information stored at the backend system based at least in part on the account identification information read from the chip card. In such embodiments, the CCID includes a processing device configured for authenticating the cardholder as the owner of the account based at least in part on the account identification information read from the chip card and the account information received from the backend system. In some such embodiments, the processing device is further configured for comparing the read account identification information with the account information received from the backend system.

In some embodiments, the processing device is further configured for locking the cardholder desired PIN using a key stored on one of the CCID or the chip card. In some embodiments, the chip card input/output device is further configured for receiving a locked cardholder desired PIN that has been locked using a key stored on one of the CCID or the chip card. In some embodiments, the chip card input/output device is further configured for receiving a message from the chip card that the PIN change script was run successfully, and the network communication device is further configured for communicating a message to the host that the PIN has been changed successfully based at least in part on the message received from the chip card.

In some embodiments, the chip card interface device also includes a housing, a processing device, and a memory device connected to the processing device. In such embodiments, the processing device is configured to erase data stored on the memory device when the integrity of the housing is compromised.

According to another embodiment of the present invention, a method is disclosed for communicating with a chip card issued by an issuing bank, associated with an account, and having an embedded processing device and an embedded memory device and carried by a cardholder. The method is also for authenticating and changing a personal identification number (PIN) stored in the memory device of the chip card using a chip card interface device (CCID). The method includes receiving a cardholder current PIN and a cardholder desired PIN; communicating the cardholder current PIN to the chip card along with a command to verify the authenticity of the cardholder current PIN; communicating the cardholder desired PIN to a backend system maintained by the issuing bank; and receiving and forwarding a PIN change script from the backend system to the chip card.

In some embodiments, before communicating the cardholder desired PIN to the backend system, the method includes initiating an online session with the backend system maintained by the issuing bank. In some embodiments, receiving a cardholder desired PIN includes receiving a first cardholder desired PIN and a second cardholder desired PIN, and, after communicating the cardholder current PIN to the chip card and before communicating the cardholder desired PIN to a backend system, the method includes comparing the first cardholder desired PIN and the second cardholder desired PIN.

In some embodiments, if the first cardholder desired PIN does not match the second cardholder desired PIN, the method includes re-receiving the cardholder desired PIN. In other embodiments, communicating the cardholder desired PIN to a backend system includes communicating the cardholder desired PIN through a host to the backend system. In some such embodiments, initiating an online session with the backend system maintained by the issuing bank includes communicating through a host with the backend system.

In some embodiments, the method also includes reading account identification information from the chip card; receiving account information stored at the backend system based at least in part on the account identification information read from the chip card; and authenticating the cardholder as the owner of the account based at least in part on the account identification information read from the chip card and the account information received from the backend system. In some such embodiments, authenticating includes comparing the read account identification information with the account information received from the backend system.

In some embodiments, the communicating the cardholder desired PIN to a backend system includes locking the cardholder desired PIN using a key stored on one of the CCID or the chip card. In some, the communicating includes receiving a locked cardholder desired PIN that has been locked using a key stored on one of the CCID or the chip card. In some embodiments, the method includes receiving a message from the chip card that the PIN change script was run successfully and communicating a message to the host that the PIN has been changed successfully based at least in part on the message received from the chip card.

According to another embodiment of the present invention, an apparatus communicates with a chip card issued by an issuing bank, associated with an account, and having an embedded processing device and an embedded memory device. The apparatus is carried by a cardholder and is also for authenticating and changing a personal identification number (PIN) stored in the memory device of the chip card. The apparatus includes means for receiving a cardholder current PIN and a cardholder desired PIN; means for communicating the cardholder current PIN to the chip card along with a command to verify the authenticity of the cardholder current PIN; means for communicating the cardholder desired PIN to a backend system maintained by the issuing bank; and means for receiving and forwarding a PIN change script from the backend system to the chip card.

According to another embodiment of the present invention, a computer program product includes a non-transitory computer-readable medium having computer-readable instructions for execution by a chip card interface device (CCID). The instructions include instructions for communicating with a chip card having an embedded processing device and an embedded memory device and carried by a cardholder and authenticating and changing a personal identification number (PIN) stored in the memory device of the chip card. The instructions also include instructions for receiving a cardholder current PIN and a cardholder desired PIN; instructions for communicating the cardholder current PIN to the chip card along with a command to verify the authenticity of the cardholder current PIN; instructions for communicating the cardholder desired PIN to a backend system maintained by the issuing bank; and instructions for receiving and forwarding a PIN change script from the backend system to the chip card.

In some embodiments, the instructions include, before instructing communicating the cardholder desired PIN to a backend system, instructions for initiating an online session with the backend system maintained by the issuing bank. In some embodiments, the instructions for receiving a cardholder desired PIN include instructions for receiving a first cardholder desired PIN and a second cardholder desired PIN and the instructions also include instructions for comparing the first cardholder desired PIN and the second cardholder desired PIN. In some embodiments, the instructions include instructions for, if the first cardholder desired PIN does not match the second cardholder desired PIN, re-receiving the cardholder desired PIN. In other embodiments, the instructions for communicating the cardholder desired PIN to a backend system include instructions for communicating the cardholder desired PIN through a host to the backend system. In yet other embodiments, the instructions for initiating an online session with the backend system maintained by the issuing bank include instructions for communicating through a host with the backend system.

In other embodiments, the instructions also include instructions for reading account identification information from the chip card; instructions for receiving account information stored at the backend system based at least in part on the account identification information read from the chip card; and instructions for authenticating the cardholder as the owner of the account based at least in part on the account identification information read from the chip card and the account information received from the backend system. In some such embodiments, the instructions for authenticating include instructions for comparing the read account identification information with the account information received from the backend system.

In some embodiments, the instructions for communicating the cardholder desired PIN to a backend system include instructions for locking the cardholder desired PIN using a key stored on one of the CCID or the chip card. In some other embodiments, the instructions for communicating the cardholder desired PIN to a backend system include instructions for receiving a locked cardholder desired PIN that has been locked using a key stored on one of the CCID or the chip card.

In some embodiments, the instructions include instructions for receiving a message from the chip card that the PIN change script was run successfully and instructions for communicating a message to the host that the PIN has been changed successfully based at least in part on the message received from the chip card.

According to another embodiment of the present invention a system is configured for communicating with a chip card issued by an issuing bank, the chip card having an embedded processing device connected with an embedded memory device and carried by a cardholder. The system is also configured for authenticating and changing a personal identification number (PIN) stored in the memory device of the chip card. The system includes a host configured for interacting with the cardholder and communicating across a network and a chip card interface device configured for communicating with the host and the chip card. The chip card interface device includes a PIN entry device (PED) configured for receiving a cardholder current PIN and a cardholder desired new PIN; and a chip card input/output device configured for communicating a verify command to the chip card including data corresponding to the received cardholder current PIN. The chip card input/output device is also configured for receiving a verification message from the chip card indicating that authentication of the cardholder current PIN was successful. The chip card interface device also includes a network communication device configured for communicating the cardholder desired new PIN to the host and across the network.

In some embodiments, the system includes a backend system configured for receiving the cardholder desired new PIN from the network communication device, storing new PIN data representing the cardholder desired new PIN, creating a PIN change script including data corresponding to the cardholder desired new PIN and instructions for the chip card to store the cardholder desired new PIN in place of a current PIN, and communicating the PIN change script across the network, through the host and the chip card interface device to the chip card. In other embodiments, the host also includes a processing device configured for controlling the chip card interface device.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a block diagram of one embodiment of the personal identification number changing system.

FIG. 2 is a block diagram of one embodiment of a chip card interface device (CCID) communicating with backend systems maintained by an issuing bank across a network and via a host.

FIG. 3 is a flowchart illustrating one embodiment of the personal identification number changing method.

FIG. 4 is a flowchart illustrating one embodiment of sub-steps regarding reading card account identification information.

FIG. 5 is a flowchart illustrating one embodiment of sub-steps regarding initiating an “online” session with the backend systems maintained by the issuing bank.

FIG. 6 is a flowchart illustrating one embodiment of sub-steps regarding receiving cardholder input corresponding to the current PIN.

FIG. 7 is a flowchart illustrating one embodiment of sub-steps regarding receiving cardholder input corresponding to the desired new PIN.

FIG. 8 is a flowchart illustrating one embodiment of sub-steps regarding communicating the new PIN to and storing the new PIN at the backend systems.

FIG. 9 is a flowchart illustrating one embodiment of writing the new PIN to the chip card.

FIG. 10 is a flowchart illustrating one embodiment of a stored PIN checking method.

FIG. 11 is a flowchart illustrating one embodiment of a compromised housing memory erasing method.

### DETAILED DESCRIPTION OF EMBODIMENTS OF THE INVENTION

Embodiments of the present invention now will be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

Systems, methods, and computer program products are provided for enabling a cardholder to authenticate and change a current PIN associated with a chip card using a chip card interface device (CCID). The CCID has a chip card input/output device configured for interacting with the chip card. A PIN entry device (PED), which is typically part of the CCID, but in some embodiments is part of a host connected to the chip card interface device, or a standalone device, receives from the cardholder a current PIN, which is communicated to the chip card along with a verify command. The chip card compares the current PIN input by the cardholder with the PIN stored on the chip card. If the cardholder input is verified, the cardholder can input a desired new PIN.

The cardholder is prompted to enter the desired new PIN twice in some embodiments. The desired new PIN entries are compared for consistency, and if consistent, the desired new PIN is locked by the chip card. The CCID has a network communication device connected with a peripheral interface of a host, e.g. a personal computer. The network communication device communicates the locked PIN through the host to the backend systems maintained by the issuing bank. The backend systems unlock the PIN and store an offset value representing the desired PIN. The backend system then creates a PIN change script including data corresponding to the new PIN. This PIN change script is communicated to the chip card over the network and through the host. The chip card runs the PIN change script, which instructs the chip card to store the new PIN in place of the previous PIN. In some embodiments, the cardholder can choose to verify the PIN change was successful. In other embodiments, the CCID includes a housing, and if the housing is compromised, the processing device of the CCID formats or entirely erases the data stored in the memory device of the CCID in order to prevent conversion of sensitive data such as account information or encryption keys.

As used herein, unless specifically limited by the context, the term “transaction” may refer to a purchase of goods or services, a withdrawal of funds, an electronic transfer of funds, a payment transaction, a credit transaction, a PIN change transaction or other transaction involving a bank account. As used herein, a “bank card” refers to a credit card, debit card, ATM card, check card, or the like, and a “bank account” refers to a credit account, debit account, deposit account, checking account, or the like. Although the phrases “bank card” and “bank account” include the term “bank,” the card need not be issued by a bank, and the account need not be maintained by a bank and may instead be issued by and/or maintained by other financial institutions. As discussed above, as used herein the terms “chip card” or “smart card” refer to a bank card having one or more electronic devices included in or on the card. The electronic device(s) may be or include processing device(s), memory device(s), communication device(s), the like, or any other electronic device(s).

As used herein, a “processing device” generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities.

As used herein, a “communication device” generally includes a modem, server, transceiver, and/or other device for communicating with other devices directly or via a network, and/or a user interface for communicating with one or more users. As used herein, a “user interface” generally includes a display, mouse, keyboard, button, touchpad, touch screen, microphone, speaker, LED, light, joystick, switch, buzzer, bell, and/or other user input/output device for communicating with one or more users.

As used herein, a “memory device” generally refers to a device or combination of devices including one or more forms of computer-readable media for storing instructions, computer-executable code, and/or data thereon. Computer-readable media is defined in greater detail herein below. It will be appreciated that, as with the processing device, each communication interface and memory device may be made up of a single device or many separate devices that conceptually may be thought of as a single device.

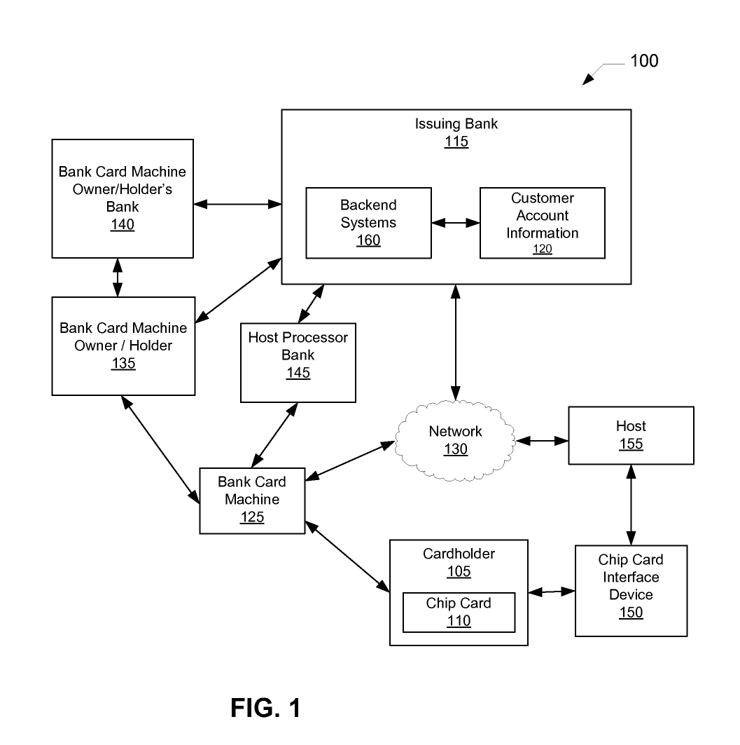

FIG. 1 illustrates one embodiment of the PIN change system 100. The system 100 generally involves a cardholder 105 holding a chip card 110. As described above, the chip card 110 may be, for example, a credit, debit, or other type of card including an electronic device embedded in or on the card. The chip card 110 is used during a transaction involving one or more accounts associated with the chip card 110 and maintained by an issuing bank 115. In a typical bank card transaction, the cardholder 105 is the customer who owns the account maintained by the issuing bank 115. However, in other chip card transactions or attempted chip card transactions, the cardholder 105 is not the customer. For example, the customer may authorize a friend or family member to perform a transaction with the chip card 110, in which case the friend or family member is considered the “cardholder” for purposes herein. In another example, the customer is a victim of a robbery where the robber steals the customer's chip card 110 and attempts to perform a transaction with the chip card 110.

The issuing bank 115 is the bank or other financial institution that maintains the customer's bank account, which, as described above, may be a credit account, debit account, or other account. Accordingly, the issuing bank 115 is also, typically, the financial institution that issues the chip card 110. In this regard, the issuing bank 115 includes a memory system housing a datastore of customer account information 120. The memory system housing the customer account information is typically part of or in communication with one or more backend systems 160 maintained by the issuing bank.

A “backend system” is one or more computers or computer-like devices such as one or more server systems, and a backend system typically has one or more processing devices such as a server and typically includes one or more memory devices as well as one or more communication devices.

The customer account information 120 generally includes an account number, an account balance, transaction information about previous transactions, and/or other financial and non-financial information about the customer and the customer's account. As described in greater detail below, embodiments of the present invention permit customers to change a PIN associated with an account without requiring access to an ATM. In some instances, accounts have more than one associated PIN for various purposes. For example, in one application, an account is given a regular PIN as well as a “panic” PIN for the customer to enter if he or she is being robbed. Generally, the PIN or PINs are stored as part of the customer account information 120 at the backend systems using an offset value that represents the value of the PIN. The PIN(s) are also stored on the chip card 110 associated with one or more accounts and issued by the issuing bank 115. In one embodiment, the PIN is a string of numbers, such as a string of four or six numbers. In other embodiments, however, the PIN may not be a number at all and may include a string of alphabetic or alphanumeric characters and/or other symbols and characters.

In some embodiments, the “Europay MasterCard VISA” (EMV) standard is used as the protocol for communication between the chip card 110 and a chip card-compatible bank card machine 125 or a chip card interface device 150 in accordance with the present invention. In other embodiments other standards of communication are used. EMV is a standard for interoperation of chip cards 110 and chip card-compatible bank card machines 125 such as POS terminals, ATMs and the like that was named for the three companies that originally cooperated to develop the standard. The EMV standard defines the interaction between the chip cards and chip card input/output devices. EMV governed transactions typically utilize cryptographic algorithms generally considered safer than traditional offline magnetic stripe transaction authentication. Types of algorithms used include, but are not limited to, DES, Triple-DES, RSA, SHA, and the like.

The system 100 generally also includes a bank card machine 125. In one embodiment, the bank card machine 125 is an ATM. In other embodiments, the bank card machine 125 is a point-of-sale terminal, such as a bank card terminal at the register of a grocery store or a pay-at-the-pump terminal at a gas station. The bank card machine 125 is configured to communicate with the issuing bank 115 via a network 130. The bank card machine 125 is owned, held, or otherwise associated with a bank card machine owner/holder 135. In one embodiment, the bank card machine owner/holder 135 is the issuing bank 115. For example, many banks have their own ATMs. In such an embodiment, the bank card machine 125 may communicate directly with the issuing bank 115 over the network 130 or through one or more other entities.

In other embodiments, however, the bank card machine owner/holder 135, is another bank or financial institution, a merchant, or the like. In such embodiments, the bank card machine 125 may communicate with the issuing bank 115 through the bank card machine owner/holder 135, the bank card machine owner/holder's bank 140, and/or one or more other entities.

The bank card machine owner/holder 135 may have a bank 140 that maintains a bank account for the bank card machine owner/holder 135. The bank card machine owner/holder's bank 140 may be the same as or different from the issuing bank 115. For example, where the bank card machine 125 is a POS terminal at a merchant's store, the bank card machine owner/holder 135 may be the merchant, and the bank card machine owner/holder's bank 140 may be the receiving bank that maintains the merchant's account and obtains payment from the issuing bank 115 for bank card purchases made at the merchant's store.

In another example, the bank card machine 125 is a kiosk-style ATM owned or leased by a merchant, such as a gas station or convenience store. In such an embodiment, although the bank card machine owner/holder (the “merchant” in this example) 135 may provide the money in the bank card machine 125, the bank card machine 125 may be operated by a host processor bank 145. In such an embodiment, the bank card machine 125 may communicate with the issuing bank 115 through the host processor bank 145. Where the transaction involves a withdrawal of cash from the bank card machine 125, the issuing bank 115 transfers funds to the host processor bank 145 via, for example, an electronic funds transfer, and the host processor bank 145 then transfer the funds via the Automated Clearing House (ACH) to the merchant's bank account maintained by the merchant's bank 140. In this way, the merchant 135 is reimbursed for the funds dispensed at the bank card machine 125.

During some transactions, the bank card machine 125 establishes a connection to the backend systems 160 for various purposes including, potentially, verification of cardholder PIN inputs. Such a connection is considered an “online” transaction, and an “offline” transaction is one in which the bank card machine 125 does not establish a connection with the backend systems 160 of the issuing bank 115.

In order to change the PIN number associated with the account and stored on the chip card 110, a cardholder 105 must either perform an online transaction at the bank card machine 125, which communicates with the issuing bank 115 via one or more of the several pathways discussed in greater detail above, or, the cardholder 105 can use a chip card interface device 150 (CCID) in accordance with embodiments of the present invention. The chip card interface device 150 forms an online connection to the issuing bank 115 via a host 155 such as, but not limited to, a personal computer and through the network 130 such as, but not limited to, the Internet.

The chip card interface device 150 is configured for recognizing the chip carried on or in the chip card 110, reading data from the chip, and writing data to the chip. The chip card interface device 150 is also configured for connecting with the issuing bank 115 via the host 155 and the network 130. For example, the chip card interface device 150 is configured for connecting with a host 155 such as a computer, ATM, POS terminal, mobile telephone or smartphone or the like via a communication protocol, either wired or wireless. For example, in one embodiment, the chip card 110 communicates with the chip card interface device 150, which communicates with a personal computer via a Universal Serial Bus (USB) connection. The chip card interface device 150 is configured to provide local or “offline” authentication of the customer's PIN in some applications, but is configured for making an online authentication during a PIN change process. The device 150 is also configured for providing the cardholder 105 an interface with which to change the PIN(s) saved on the chip card 110 and associated with one or more of the accounts associated with the chip card.

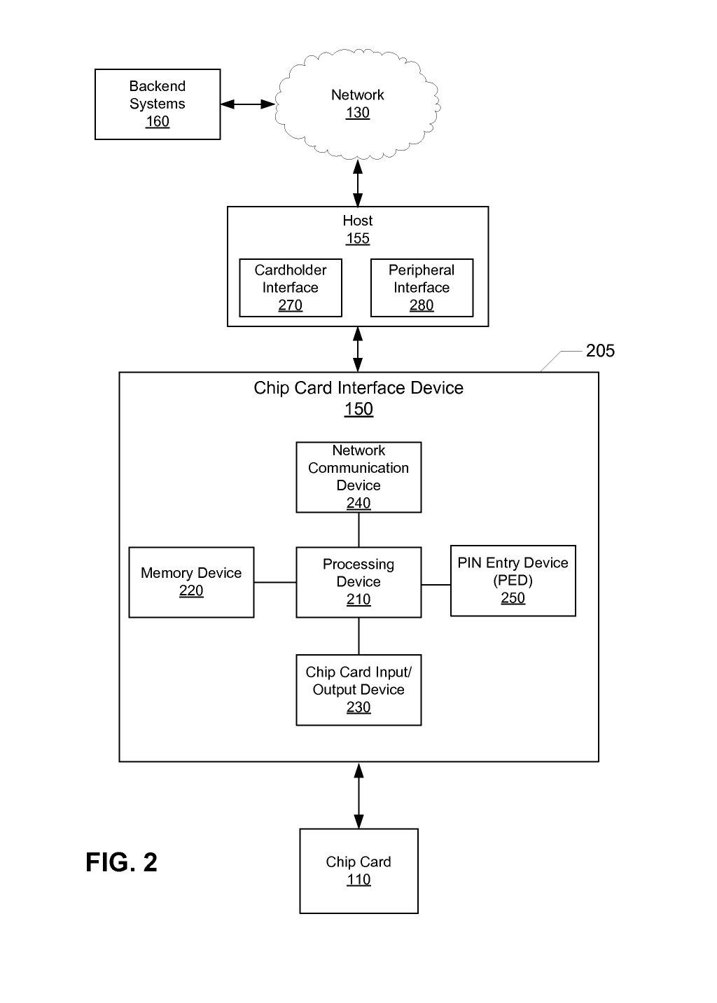

As shown in FIG. 2, the host 155 includes a cardholder interface 270 and a peripheral interface 280 in some embodiments. The cardholder interface 270 is any device configured for interacting with a user, including either communicating to the user, receiving input from the user or both. The cardholder interface 270, in some embodiments, for example is one or more of a display, a keyboard, a keypad, a mouse, a roller ball, a track pad, a touch pad, a touch screen, a speaker, and the like. The peripheral interface 280 is a device and/or software control module configured for connecting with a peripheral using one or more wired or wireless protocols. For example, in one embodiment the peripheral interface is a USB port controlled by a USB controller script running on the host 155. In this example, the CCID 150 network communication device 240 may be a USB interface for coupling with the USB port running on the host 155.

Numerous other entities may also be involved in embodiments of the present invention, but are not shown in FIG. 1 and FIG. 2 discussed below for the sake of clarity. For example, the system may involve an automated clearing house and/or one or more other financial institutions involved in processing bank card transactions, such as POS purchase transactions and ATM transactions.

Furthermore, although only a single representation of a network 130 is illustrated in FIG. 1 and FIG. 2 discussed below, the network 130 may comprise a plurality of separate and discrete networks. For example, the network 130 that is used to communicate information between the issuing bank 115 and the bank card machine 125 may be the same or different than the network 130 used to communicate information between the issuing bank 115 and the chip card interface device 150. The network 130 may include a local area network (LAN), a wide area network (WAN), and/or a global area network (GAN). In this regard, the network 130 may include the Internet, an intranet, an extranet, a telephonic network, and/or a combination of these networks. The network 130 may also include a direct electrical, optical, or wireless connection between one or more of the entities and devices shown in FIGS. 1 and 2.

FIG. 2 illustrates a chip card interface device 150 interacting with a chip card 110 and a network 130. The chip card interface device 150 includes, in some embodiments, a housing 205, a processing device 210 connected to and configured for controlling a memory device 220, a chip card input/output device 230 configured for communicating with the chip card 110, a network communication device 240 configured for communicating with the network 130, and a PIN entry device (PED) 250 configured for receiving cardholder input such as input corresponding to the current PIN associated with the chip card or input corresponding to the cardholder's desired new PIN.

The chip card input/output device 230 is configured for reading data, such as account data corresponding to one or more accounts, from the chip card 110 as well as transmitting data to be updated on the chip card 110. In some embodiments, the chip card 110 includes electrical contacts and the chip card input/output device 230 also includes electrical contacts for coupling with and communicating via the electrical contacts of the chip card 110. For example, in some embodiments, the chip card communicates using the International Organization for Standardization (ISO) 7816 and ISO 7810 standards. In other embodiments, the chip card 110 includes a wireless communication device and the chip card input/output device 230 also includes a wireless communication device for coupling with and communicating via the wireless communication device of the chip card 110. For example, in some embodiments, the chip card communicates using the ISO 14443 standard for contactless smartcard communications, and in other embodiments other types of communication such as radio frequency identification (RFID) wireless communication is used.

The network communication device 240 is configured for communicating with the network 130 via the host 155. In some embodiments, the network communication device 240 includes a wired interface for connecting with a personal computer such as a Universal Serial Bus (USB) connection, an IEEE 1394 (“Firewire”) protocol connection, or the like. In other embodiments, the network communication device 240 includes a wireless interface for connecting with the cardholder's personal computer such as a Bluetooth device, a Wi-Fi device, a radio frequency communication device, or the like.

The PED 250 is configured for receiving a cardholder current PIN input from the cardholder. The PED 250 is also configured for receiving a cardholder desired PIN input corresponding to the cardholder's desired new PIN. The PED 250, in some embodiments, is part of the chip card interface device 150, and in other embodiments, it is part of the host 155. In yet other embodiments, the PED 250 is a standalone device in communication with the chip card interface device 150. The PED 250 is any input device capable of receiving input from the cardholder indicating a PIN. For example, in one embodiment, the cardholder input device 245 is a nine-digit keypad. In other embodiments, the cardholder input device 245 is a keyboard or included on a keyboard, a touch-screen, or the like.

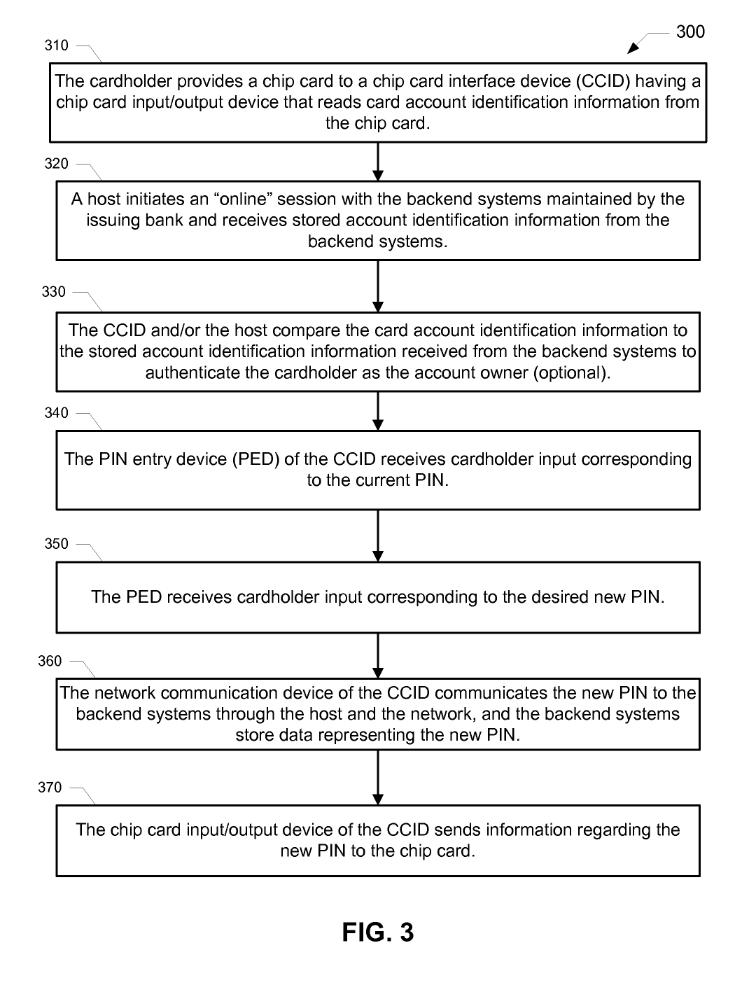

FIG. 3 is a flowchart illustrating a method 300 for authenticating and changing a PIN stored in the memory device of the chip card 110. First, as represented by block 310, the cardholder 105 provides a chip card 110 to the CCID 205 having a chip card input/output device 230. The chip card input/output device reads card account identification information from the chip card 110. For example, the chip card stores data corresponding to an account number identifying an account associated with the chip card 110. The chip card input/output device 230 determines the account number by reading the data stored on the chip card 110.

Next, as represented by block 320, a host 155 initiates an “online” session with the backend systems 160 maintained by the issuing bank 115. The host 155 also receives stored account identification information from the backend systems 160. For example, in one embodiment, an account owner's account number is stored in the backend system and is retrieved by the host 155 during initiation of the online session.

As represented by block 330, the CCID 150 compares the card account identification information to the stored account identification information received from the backend systems 160 in order to authenticate the cardholder as the account owner. This step, in some embodiments, is performed by the host 155, and in some embodiments, it is optional. That is, in some applications, for example, this additional layer of authentication is not required, such as during a transaction involving an amount of money under a pre-determined threshold.

Next, as represented by block 340, the PED 250 of the CCID 150 receives cardholder input corresponding to the current PIN. Then, the PED 250 receives cardholder input corresponding to the cardholder's desired new PIN as represented by block 350. In some embodiments, as discussed in further detail below, the desired new PIN is entered more than once and the entries are compared for consistency in order to ensure the cardholder properly entered the desired new PIN.

Next, as represented by block 360, the network communication device 240 of the CCID 150 communicates the new PIN to the backend systems 160 through the host 155 and the network 130. The backend systems 160 then store the PIN. In some embodiments, the backend systems 160 store data related to the actual PIN value, such as, for example an offset value that can be manipulated by applying a re-generable default PIN value in order to determine the actual PIN value. Storing an offset value in this manner provides an additional layer of fraud protection over and above merely storing the PIN value itself.

Finally, as represented by block 370, the chip card input/output device 230 of the CCID 150 sends information regarding the new PIN to the chip card 110. As discussed in further detail below, the new PIN is communicated from the backend systems 160 as part of or in addition to a change PIN script created by the backend systems 160 for instructing the chip card to replace the previous PIN with the new PIN.

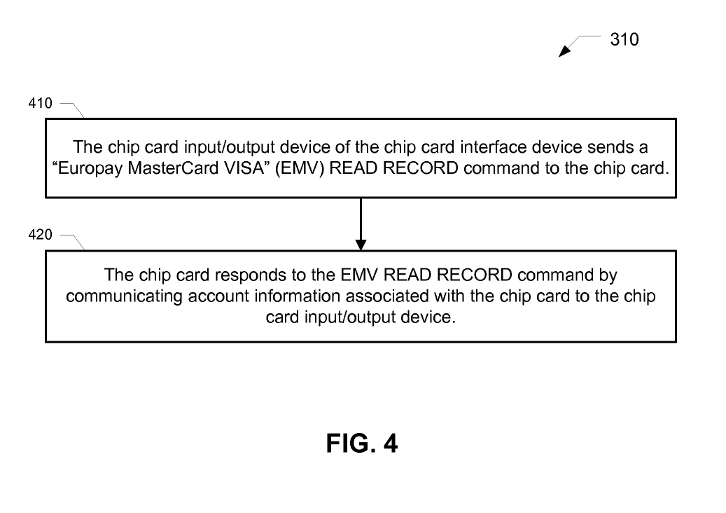

Referring now to FIG. 4, one embodiment of step 310, reading card account identification information from the chip card 110, is illustrated in further detail. In a first sub-step represented by block 410, the chip card input/output device 230 sends an EMV READ RECORD command to the chip card 110. The command instructs the chip card 110 to retrieve the requested information from its memory and communicate the account information associated with the chip card 110 to the chip card input/output device 230, as represented by block 420.

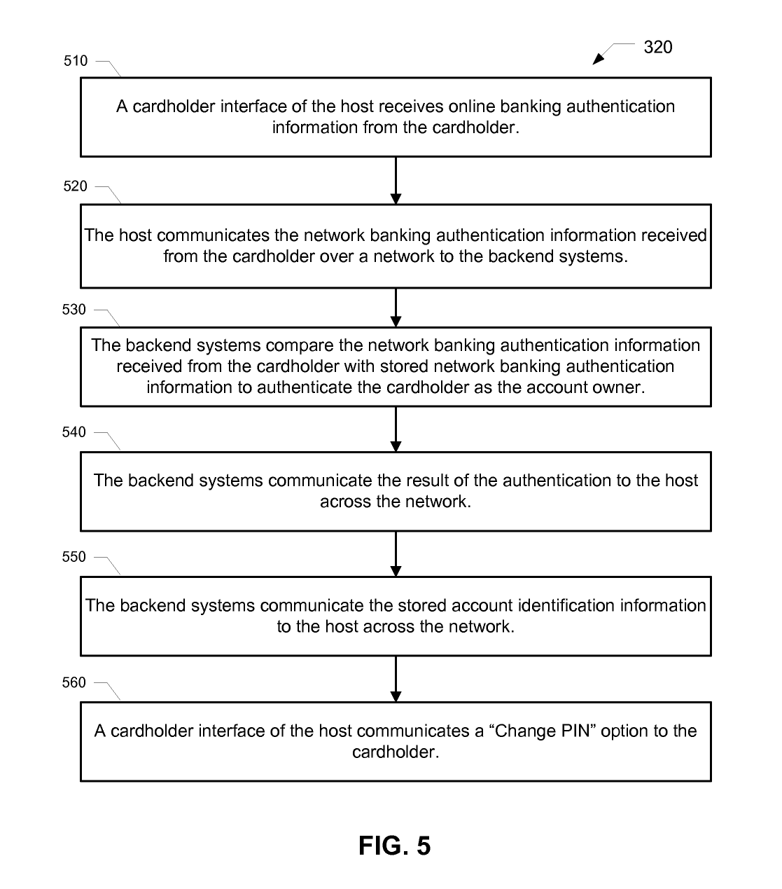

Referring now to FIG. 5, one embodiment of step 320 is illustrated in further detail. In step 320, the host 155 initiates an online session with the backend systems 160 maintained by the issuing bank 115. First, the cardholder interface 270 of the host 155 receives network banking authentication information from the cardholder 105 as represented by block 510. Typically, “network banking” refers to Internet banking solutions such as, for example, a secure webpage maintained by the issuing bank 115 designed to provide an account owner various tools for managing the owner's bank account while connected to the network, that is, the Internet. In other embodiments, various other networks could be used individually or in combination as discussed further regarding network 130.

Next, as represented by block 520, the host 155 communicates network banking authentication information received from the cardholder 105 over a network 130 to the backend systems 160. Then, as represented by block 530, the backend systems 160 compare the network banking authentication information received from the cardholder 105 with stored network banking authentication information. If the two match, then the cardholder 105 is authenticated as the account owner. The network banking authentication information, in one embodiment, includes a username and a password associated with the username and both associated with one or more accounts. The username and password, in this example, can be stored open, that is, with any security measures to deter fraud, or may be locked, encrypted, or otherwise protected while stored in the backend systems 160.

Next, as represented by blocks 540 and 550, the backend systems 160 communicate the result of the authentication as well as the stored account identification information to the host 155 across the network 130. Then, as represented by block 560, the cardholder interface 270 of the host 155 communicates a “Change PIN” option to the cardholder 105. In one embodiment, for example, the “Change PIN” message is a link such as a hyperlink on the network/online banking webpage discussed above. In other embodiments, the option to change the PIN is communicated in another way such as a text or video message displayed on a video monitor that is part of the host 155, and in another embodiment, the change PIN option is communicated aurally, and the cardholder is given the option to respond verbally or otherwise, such as by providing input to another cardholder interface 270.

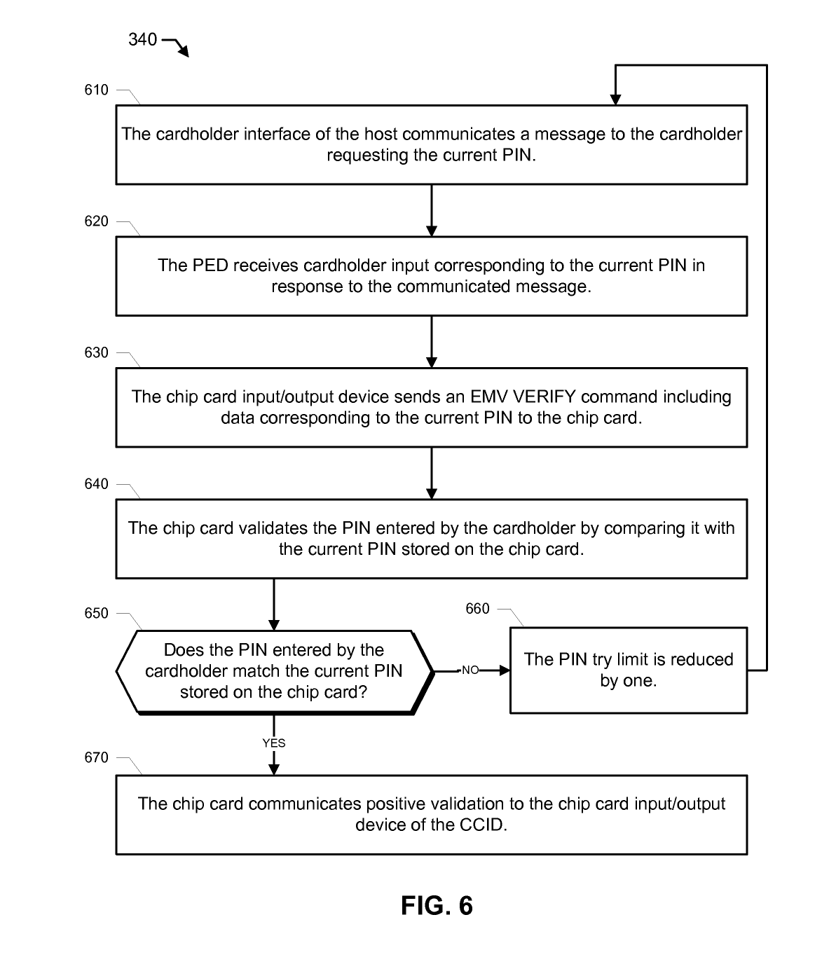

Referring now to FIG. 6, one embodiment of step 340 is illustrated in further detail. In step 340, the PED of the CCID receives cardholder 105 input corresponding to the current PIN. The first sub-step in this embodiment is represented by block 610, in which the cardholder interface 270 of the host 155 communicates a message to the cardholder 105 requesting the current PIN. Then, as represented by block 620, the PED receives the cardholder input corresponding to the current PIN in response to the communicated message. Next, as represented by block 630, the chip card input/output device 230 sends an EMV VERIFY command including data corresponding to the current PIN entered by the cardholder 105 to the chip card 110. The chip card 110, as represented by block 640, then validates the PIN entered by the cardholder by comparing it with the current PIN stored on the chip card 110.

If the PIN entered by the cardholder does not match the current PIN stored on the chip card 110, as represented by decision block 650, the PIN try limit is reduced by one as represented by block 660, and the process is re-started at sub-step 610. The PIN try limit is a pre-determined threshold of changes for a user to input a PIN before the host 155, the PED 250, the CCID 150 and/or the chip card 110 disallow the user from attempting additional PIN entries. The process of FIG. 6 may be repeated several times until a sufficient number of PIN entries have been attempted such that the PIN try limit is achieved. In some embodiments, additional measures are taken such as contacting the account owner to inform the owner that the PIN try limit was eclipsed or taking other similar pre-cautionary measures.

If the PIN entered by the cardholder does match the current PIN stored on the chip card 110, as represented by decision block 650, then the chip card 110 communicates positive validation to the chip card input/output device 230 of the CCID 150.

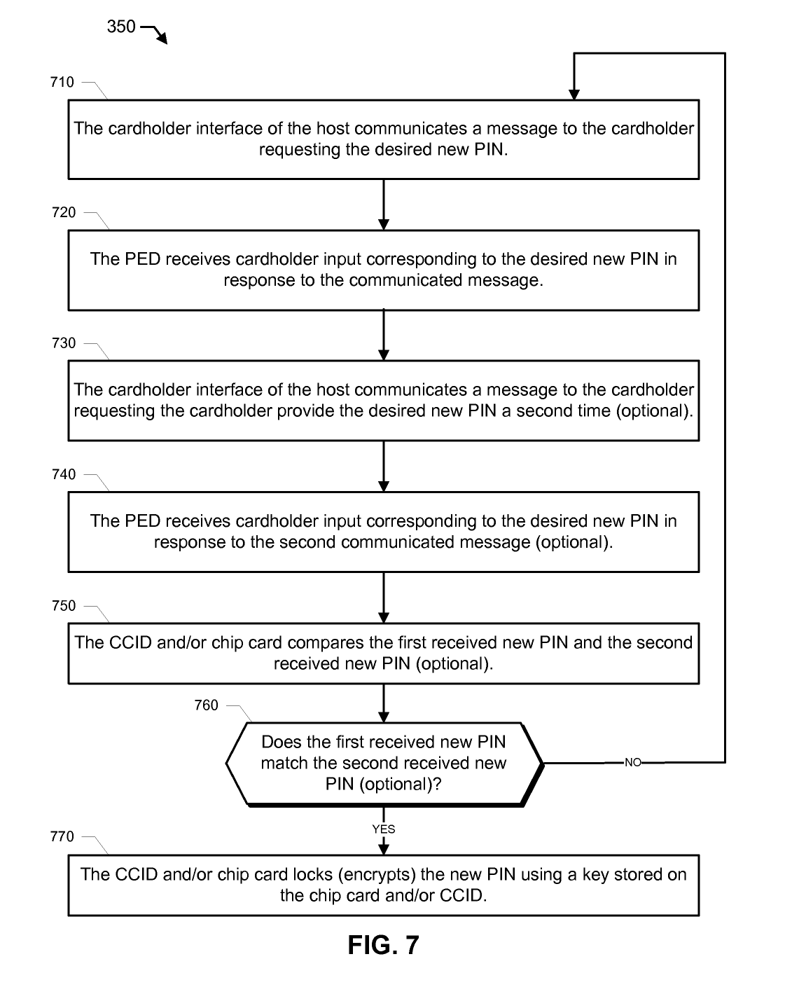

Referring now to FIG. 7, one embodiment of step 350 is illustrated in greater detail. In step 350, the PED receives cardholder input corresponding to the desired new PIN. In the first sub-step, as represented by block 710, the cardholder interface 270 of the host 155 communicates a message to the cardholder 105 requesting the desired new PIN. Next, as represented by block 720, the PED 250 receives cardholder 105 input corresponding to the desired new PIN in response to the communicated message. Then, in some embodiments, the desired new PIN is entered one or more additional times in order to ensure consistency and accuracy of the desired new PIN. Specifically, as represented by block 730, the cardholder interface 270 of the host 155 communicates another message to the cardholder 105 requesting the cardholder 105 provide the desired new PIN a second time. Then, the PED 250, as represented by block 740, receives the cardholder 105 input corresponding to the desired new PIN in response to the second communicated message.

Next, the CCID 150 and/or chip card 110 compares the first received desired new PIN with the second received desired new PIN as represented by block 750. As represented by decision block 760, if the first received new PIN does not match the second received new PIN, the process is repeated to sub-step 710, requesting cardholder 105 entry of the desired new PIN. If the PINs match, the CCID 150 and/or chip card 110 locks (or encrypts) the new PIN using a key stored on the chip card 110 and/or in the CCID 150 as represented by block 770.

Various types of encryption individually or in combination are used in various embodiments and in various steps and sub-steps of the methods of the invention. For example, in one embodiment, symmetric keys such as Triple-DES or AES are used to encrypt and decrypt the various messages and data communicated to and from the chip card 110. In another embodiment, for example, asymmetric keys such as RSA are used. In other embodiments, other types of encryption, cryptography or other security measures are used to secure communications and data.

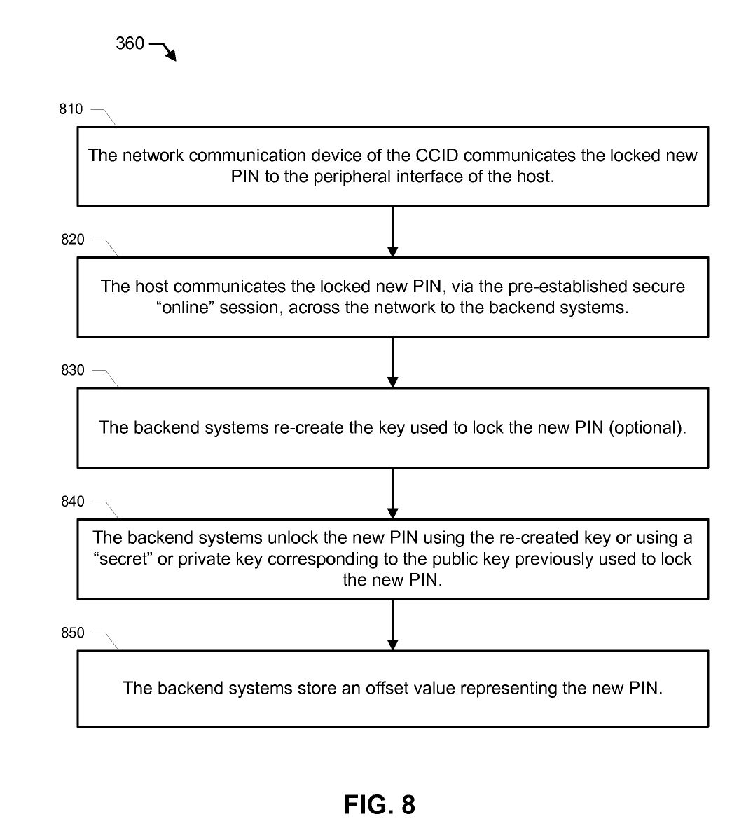

Referring now to FIG. 8, one embodiment of step 360 is illustrated in greater detail. In step 360, the network communication device 240 of the CCID 150 communicates the new PIN to the backend systems 160 through the host 155 and the network 130. First, the network communication device 240 of the CCID 150 communicates the locked new PIN to the peripheral interface 280 of the host 155 as represented by block 810. Then, the host 155 communicates the locked new PIN, via the pre-established, secure online session between the host 155 and the backend systems 160, across the network to the backend systems 160. In one embodiment, for example, there is already established a Secure Sockets Layer (SSL) or Transport Layer Security (TLS) tunnel or data communication pathway established by the initiation of an online session during step 320. Accordingly, the new PIN is both locked and communicated across an encrypted tunnel for multiple layers of security.

Next, in some embodiments, the backend systems 160 re-create the key used to lock the new PIN as represented by block 830. In other embodiments, the backend systems 160 use a “secret” or private key corresponding to the public key previously used to lock the new PIN, and in these embodiments, re-creating the key (step 830) is typically unnecessary. Then, the backend systems 160 unlock the new PIN using the re-created key or the secret key as represented by block 840. In other embodiments, as discussed above, various other methods of encryption and decryption are used. Finally, as represented by block 850, the backend systems 160 store an offset value representing the new PIN. The offset value, as discussed above, provides a layer of fraud protection because the PIN itself is not stored. In other embodiments, however, the PIN itself is stored or other storage methods are used, either secure or insecure.

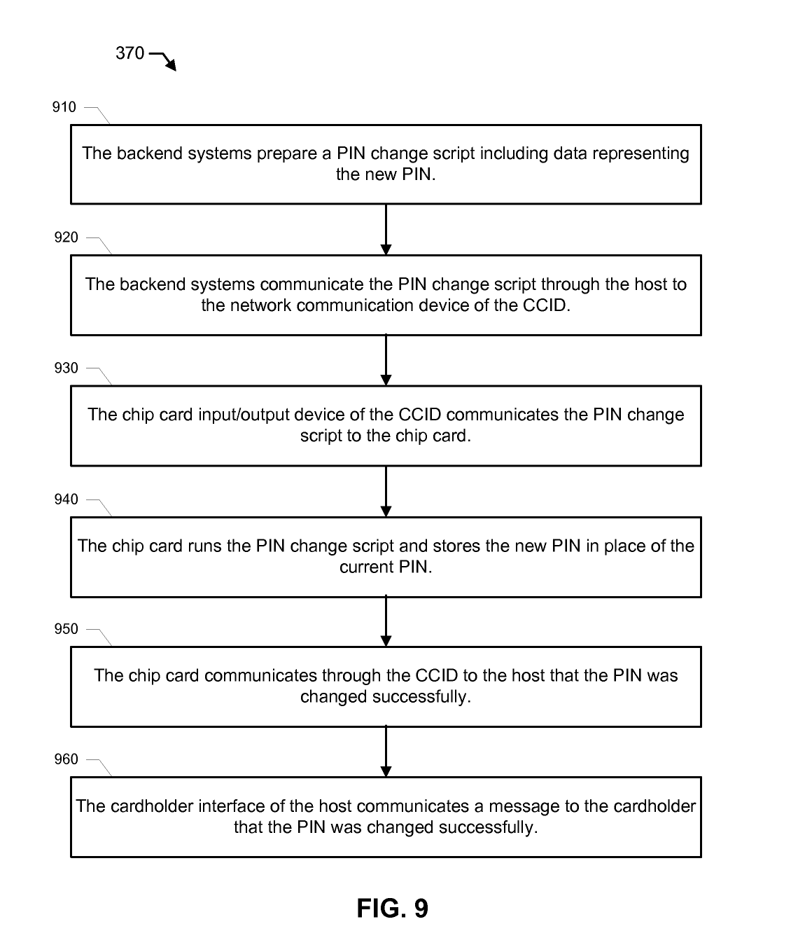

Referring now to FIG. 9, one embodiment of step 370 is illustrated in greater detail. In step 370, the chip card input/output device 230 of the CCID 150 communicates information enabling replacing the current PIN with the new PIN on the chip card 110. In the first sub-step, as represented by block 910, the backend systems 160 prepare a PIN change script including data representing the new PIN. The script is an encrypted or message authenticated (in some embodiments) software module intended for execution by the chip card 110. Next, as represented by block 920, the backend systems 160 communicate the PIN change script across the network 130, through the host 155 to the network communication device 240 of the CCID 150. Then, as represented by block 930, the chip card input/output device 230 of the CCID 150 communicates the PIN change script to the chip card 110. Next, the chip card 110 decrypts or authenticates the PIN change script and runs the decrypted PIN change script, which instructs the chip card 110 to store the new PIN in place of the current PIN. Then, as represented by block 950, the chip card 110 communicates through the CCID 150 to the host 155 that the PIN was changed successfully. Finally, as represented by block 960, the cardholder interface 270 of the host 155 communicates a message to the cardholder 105 that the PIN was changed successfully.

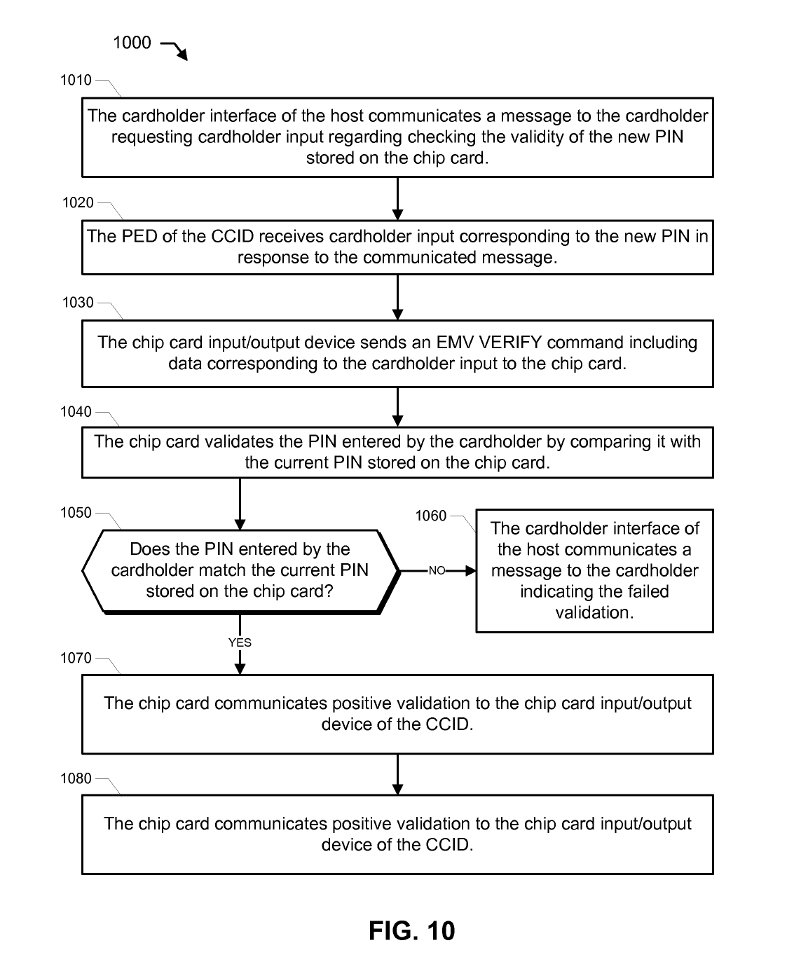

Referring now to FIG. 10, one embodiment of a method 1000 for confirming the PIN change is illustrated. Method 1000 may be included along with various embodiments of method 300. For example, method 1000 may be performed immediately following method 300 discussed above.

In step 1010, the cardholder interface 270 of the host 155 communicates a message to the cardholder requesting cardholder input regarding checking the validity of the new PIN stored on the chip card 110. Next, as represented by block 1020, the PED 250 of the CCID 150 receives cardholder 105 input corresponding to the new PIN in response to the communicated message. Then the chip card input/output device 230 send an EMV VERIFY command including data corresponding to the cardholder input to the chip card 110 as represented by block 1030. Next, as represented by block 1040, the chip card 110, validates the PIN entered by the cardholder by comparing it with the current PIN stored on the chip card 110.

If the PIN entered does not match the current PIN stored on the chip card 110, as represented by decision block 1050, then the cardholder interface 270 of the host 155 communicates a message to the cardholder indicating the failed validation as represented by block 1060. At that time, the cardholder has several options including re-trying method 1000, requesting a new PIN be issued by the issuing bank, or others. If the PIN entered by the cardholder 105 matches the current PIN stored on the chip card 110 as represented by decision block 1050, the chip card communicates positive validation to the chip card input/output device 230 of the CCID 150, and in some embodiments, a message indicating the same is communicated to the cardholder via the cardholder interface 270.

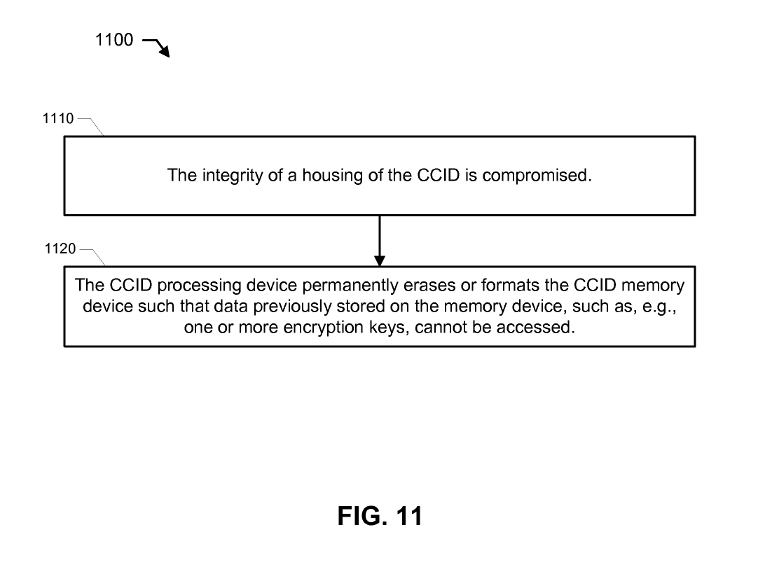

Referring now to FIG. 11, one embodiment of a method 1100 for erasing the memory of the CCID 150 in the case of a housing 205 compromise is illustrated. First, as represented by block 1110, the integrity of the housing 205 is compromised and the compromised is sensed by the CCID 150. For example, in some embodiments, the housing is secured via fasteners and the fasteners have corresponding attached sensors configured for sensing if the fasteners move with respect to the housing itself. If a threshold amount of movement is detected, the processing device 210 of the CCID 150 recognizes the movement as a compromise of the integrity of the housing 205. Accordingly as represented by block 1120, and in order to prevent malicious conversion of sensitive information and data, the CCID processing device permanently erases or formats the CCID memory device 220 such that data previously stored on the memory device 220, such as, for example, one or more encryption keys, cannot be accessed.

In summary, systems, methods, and computer program products are provided for enabling a cardholder to authenticate and change a current PIN associated with a chip card using a chip card interface device (CCID) having a chip card input/output device configured for interacting with the chip card. A PIN entry device receives from the cardholder a current PIN, which is communicated to the chip card along with a verify command. The chip card compares the current PIN input by the cardholder with the PIN stored on the chip card. If the cardholder input is verified, the cardholder can input a desired new PIN. The CCID then communicates a locked PIN through a host to the issuing bank's backend system, which unlocks the PIN and stores the desired PIN. The backend system then creates a PIN change script including the new PIN and communicates the script to the chip card over the network. The chip card runs the script, which instructs the chip card to store the new PIN in place of the previous PIN.

As will be appreciated by one of skill in the art, the present invention may be embodied as a method, apparatus (including a system), computer program product, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.”

Furthermore, embodiments of the present invention may take the form of a computer program product comprising a computer-readable storage medium having computer-usable program code/computer-readable instructions embodied in the medium. Any suitable computer-readable medium may be utilized. The computer-readable medium may be, for example but not limited to, a non-transitory, tangible medium such as an electronic, magnetic, optical, electromagnetic, infrared, or semiconductor system, apparatus, or device. More specific examples (a non-exhaustive list) of the computer-readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device; or transmission media such as those supporting the Internet or an intranet.

Computer-readable instructions for carrying out operations of the present invention may be written in an object-oriented, scripted or unscripted programming language such as Java, Perl, Smalltalk, C++, or the like. However, the computer-readable instructions for carrying out operations of the invention may also be written in conventional procedural programming languages, such as the “C” programming language or similar programming languages.

Embodiments of the present invention are described above with reference to flowchart illustrations and/or block diagrams of methods, apparatuses (systems) and computer program products according to embodiments of the invention. It will be understood that each block of the flowchart illustrations and/or block diagrams shown in FIGS. 1-11, and combinations of blocks in the flowchart illustrations and/or block diagrams, can be implemented by computer-readable instructions. These computer-readable instructions may be provided to a processor of a general purpose computer, a special purpose computer, or other programmable data processing apparatus to produce a machine, such that the instructions, which execute via the processor of the computer or other programmable data processing apparatus, create a mechanism for implementing the functions/acts specified in the flowchart and/or block diagram block or blocks.

These computer-readable program instructions may also be stored in a computer-readable memory that can direct a computer or other programmable data processing apparatus to function in a particular manner, such that the instructions stored in the computer-readable memory produce an article of manufacture including instruction mechanisms which implement the function/act specified in the flowchart and/or block diagram block or blocks.

The computer-readable program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block or blocks. Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A chip card interface device (CCID) configured for communicating with a chip card issued by an issuing bank and having an embedded processing device connected with an embedded memory device and carried by a cardholder, the chip card interface device configured for authenticating and changing a personal identification number (PIN) stored in the memory device of the chip card, the chip card interface device comprising:
a PIN entry device (PED) configured for receiving a cardholder current PIN and a cardholder desired new PIN;
a chip card input/output device configured for communicating a verify command to the chip card including data corresponding to the received cardholder current PIN, the chip card input/output device also configured for receiving a verification message from the chip card indicating that authentication of the cardholder current PIN was successful; and
a network communication device configured for communicating the cardholder desired new PIN to a host and across a network to a backend system maintained by the issuing bank and configured for receiving a PIN change script from the backend system and forwarding the PIN change script to the chip card.

2. The chip card interface device of claim 1 wherein the network communication device is further configured for initiating an online session with the backend system maintained by the issuing bank before communicating the cardholder desired PIN to the backend system.

3. The chip card interface device of claim 1 wherein the PED is further configured for receiving a first cardholder desired PIN and a second cardholder desired PIN; and wherein the chip card interface device further comprises:
a processing device configured for comparing the first cardholder desired PIN and the second cardholder desired PIN after the chip card input/output device communicates the cardholder current PIN to the chip card and before the network communication device communicates the cardholder desired PIN to a backend system.

4. The chip card interface device of claim 3 wherein the processing device is further configured for re-receiving the cardholder desired PIN if the first cardholder desired PIN does not match the second cardholder desired PIN.

5. The chip card interface device of claim 1 wherein the network communication device is further configured for communicating the cardholder desired PIN through a host to the backend system.

6. The chip card interface device of claim 2 wherein the network communication device is further configured for communicating through a host with the backend system.

7. The chip card interface device of claim 2 wherein the PED is further configured for reading account identification information from the chip card; wherein the network communication device is further configured for receiving account information stored at the backend system based at least in part on the account identification information read from the chip card; and wherein the chip card interface device further comprises:
a processing device configured for authenticating the cardholder as the owner of the account based at least in part on the account identification information read from the chip card and the account information received from the backend system.

8. The chip card interface device of claim 7 wherein the processing device is further configured for comparing the read account identification information with the account information received from the backend system.

9. The chip card interface device of claim 7 wherein the processing device is further configured for locking the cardholder desired PIN using a key stored on one of the CCID or the chip card.

10. The chip card interface device of claim 1 wherein the chip card input/output device is further configured for receiving a locked cardholder desired PIN that has been locked using a key stored on one of the CCID or the chip card.

11. The chip card interface device of claim 5 wherein the chip card input/output device is further configured for receiving a message from the chip card that the PIN change script was run successfully, and wherein the network communication device is further configured for communicating a message to the host that the PIN has been changed successfully based at least in part on the message received from the chip card.

12. The chip card interface device of claim 1 further comprising:
a housing;
a processing device; and
a memory device connected to the processing device, and wherein the processing device is configured to erase data stored on the memory device when the integrity of the housing is compromised.

13. A method for communicating with a chip card issued by an issuing bank, associated with an account, and having an embedded processing device and an embedded memory device and carried by a cardholder, the method also for authenticating and changing a personal identification number (PIN) stored in the memory device of the chip card using a chip card interface device (CCID), the method comprising:
receiving a cardholder current PIN and a cardholder desired PIN;
communicating the cardholder current PIN to the chip card along with a command to verify the authenticity of the cardholder current PIN;
communicating the cardholder desired PIN to a backend system maintained by the issuing bank; and
receiving and forwarding a PIN change script from the backend system to the chip card.

14. The method of claim 13, before communicating the cardholder desired PIN to the backend system, further comprising:
initiating an online session with the backend system maintained by the issuing bank.

15. The method of claim 13 wherein receiving a cardholder desired PIN comprises receiving a first cardholder desired PIN and a second cardholder desired PIN; and wherein the method, after communicating the cardholder current PIN to the chip card and before communicating the cardholder desired PIN to a backend system, further comprises:
comparing the first cardholder desired PIN and the second cardholder desired PIN.

16. The method of claim 15 further comprising, if the first cardholder desired PIN does not match the second cardholder desired PIN, re-receiving the cardholder desired PIN.

17. The method of claim 13 wherein communicating the cardholder desired PIN to a backend system comprises communicating the cardholder desired PIN through a host to the backend system.

18. The method of claim 14 wherein initiating an online session with the backend system maintained by the issuing bank comprises:
communicating through a host with the backend system.

19. The method of claim 14 further comprising:
reading account identification information from the chip card;
receiving account information stored at the backend system based at least in part on the account identification information read from the chip card; and
authenticating the cardholder as the owner of the account based at least in part on the account identification information read from the chip card and the account information received from the backend system.

20. The method of claim 19 wherein authenticating comprises comparing the read account identification information with the account information received from the backend system.

21. The method of claim 13 wherein communicating the cardholder desired PIN to a backend system comprises:
locking the cardholder desired PIN using a key stored on one of the CCID or the chip card.

22. The method of claim 13 wherein communicating the cardholder desired PIN to a backend system comprises:
receiving a locked cardholder desired PIN that has been locked using a key stored on one of the CCID or the chip card.

23. The method of claim 17 further comprising:
receiving a message from the chip card that the PIN change script was run successfully; and
communicating a message to the host that the PIN has been changed successfully based at least in part on the message received from the chip card.

24. An apparatus for communicating with a chip card issued by an issuing bank, associated with an account, and having an embedded processing device and an embedded memory device and carried by a cardholder and also for authenticating and changing a personal identification number (PIN) stored in the memory device of the chip card, the apparatus comprising:
means for receiving a cardholder current PIN and a cardholder desired PIN;
means for communicating the cardholder current PIN to the chip card along with a command to verify the authenticity of the cardholder current PIN;
means for communicating the cardholder desired PIN to a backend system maintained by the issuing bank; and
means for receiving and forwarding a PIN change script from the backend system to the chip card.

25. A computer program product comprising a non-transitory computer-readable medium comprising computer-readable instructions for execution by a chip card interface device (CCID), the instructions for communicating with a chip card having an embedded processing device and an embedded memory device and carried by a cardholder, the instructions for authenticating and changing a personal identification number (PIN) stored in the memory device of the chip card, the instructions comprising:
instructions for receiving a cardholder current PIN and a cardholder desired PIN;
instructions for communicating the cardholder current PIN to the chip card along with a command to verify the authenticity of the cardholder current PIN;
instructions for communicating the cardholder desired PIN to a backend system maintained by the issuing bank; and
instructions for receiving and forwarding a PIN change script from the backend system to the chip card.

26. The computer program product of claim 25, the instructions, before instructing communicating the cardholder desired PIN to a backend system, further comprising:
instructions for initiating an online session with the backend system maintained by the issuing bank.

27. The computer program product of claim 25 wherein the instructions for receiving a cardholder desired PIN comprise instructions for receiving a first cardholder desired PIN and a second cardholder desired PIN; and wherein the instructions further comprise instructions for comparing the first cardholder desired PIN and the second cardholder desired PIN.

28. The computer program product of claim 27 further comprising instructions for, if the first cardholder desired PIN does not match the second cardholder desired PIN, re-receiving the cardholder desired PIN.

29. The computer program product of claim 25 wherein the instructions for communicating the cardholder desired PIN to a backend system comprise instructions for communicating the cardholder desired PIN through a host to the backend system.

30. The computer program product of claim 26 wherein the instructions for initiating an online session with the backend system maintained by the issuing bank comprise instructions for communicating through a host with the backend system.

31. The computer program product of claim 26 wherein the instructions further comprise:
instructions for reading account identification information from the chip card;
instructions for receiving account information stored at the backend system based at least in part on the account identification information read from the chip card; and
instructions for authenticating the cardholder as the owner of the account based at least in part on the account identification information read from the chip card and the account information received from the backend system.

32. The computer program product of claim 31 wherein the instructions for authenticating comprise instructions for comparing the read account identification information with the account information received from the backend system.

33. The computer program product of claim 25 wherein the instructions for communicating the cardholder desired PIN to a backend system comprise instructions for locking the cardholder desired PIN using a key stored on one of the CCID or the chip card.

34. The computer program product of claim 25 wherein the instructions for communicating the cardholder desired PIN to a backend system comprise instructions for receiving a locked cardholder desired PIN that has been locked using a key stored on one of the CCID or the chip card.

35. The computer program product of claim 29, wherein the instructions further comprise:
instructions for receiving a message from the chip card that the PIN change script was run successfully; and
instructions for communicating a message to the host that the PIN has been changed successfully based at least in part on the message received from the chip card.

36. A system configured for communicating with a chip card issued by an issuing bank, the chip card having an embedded processing device connected with an embedded memory device and carried by a cardholder, the system configured for authenticating and changing a personal identification number (PIN) stored in the memory device of the chip card, the system comprising:
a host configured for interacting with the cardholder and communicating across a network;
a chip card interface device configured for communicating with the host and the chip card, the chip card interface device comprising:
a PIN entry device (PED) configured for receiving a cardholder current PIN and a cardholder desired new PIN;
a chip card input/output device configured for communicating a verify command to the chip card including data corresponding to the received cardholder current PIN, the chip card input/output device also configured for receiving a verification message from the chip card indicating that authentication of the cardholder current PIN was successful; and
a network communication device configured for communicating the cardholder desired new PIN to the host and across the network.

37. The system of claim 36 further comprising:
a backend system configured for receiving the cardholder desired new PIN from the network communication device, storing new PIN data representing the cardholder desired new PIN, creating a PIN change script including data corresponding to the cardholder desired new PIN and instructions for the chip card to store the cardholder desired new PIN in place of a current PIN, and communicating the PIN change script across the network, through the host and the chip card interface device to the chip card.

38. The system of claim 36 wherein the host further comprises a processing device configured for controlling the chip card interface device.
